(19) United States
(12) Patent Application Publication
(10) Pub. No.: US 2010/0282690 A1
(43) Pub. Date: Nov. 11, 2010

(54) SIMULTANEOUS REDUCTION/OXIDATION PROCESS FOR DESTROYING AN ORGANIC SOLVENT

(75) Inventors: Anita R. Padmanabhan, Shrewsbury, MA (US); John Bergendahl, Pomfret Center, CT (US); Sachin Sharma, East Windsor, NJ (US)

Correspondence Address: BURNS & LEVINSON, LLP, 125 SUMMER STREET, BOSTON, MA, 02110, US

(73) Assignee: WORCESTER POLYTECHNIC INSTITUTE, Worcester, MA (US)

(21) Appl. No.: 12/593,011

(22) PCT Filed: Mar. 28, 2008
(86) PCT No.: PCT/US08/58673

§ 371 Date: Jul. 29, 2010

Related U.S. Application Data
(60) Provisional application No. 60/908,629, filed on Mar. 28, 2007.

(51) Int. Cl. C02F 1/70

(52) U.S. Cl. 210/757

(57) ABSTRACT

This invention relates to decontaminating water containing organic compounds by treating the contaminated water by adding solid phase zero valent iron (ZVI) and persulfate to destroy organic contaminants in water.

### BACKGROUND OF THE INVENTION

Trichloroethylene (TCE) was introduced into the environment primarily through emissions from metal degreasing plants. According to the United States Environmental Protection Agency from 1987 to 1993, TCE released to water and land was over 291,000 lbs. Most releases were from steel pipe and tube manufacturing industries, and the largest releases occurred in Pennsylvania and Illinois. The largest direct releases to water occurred in West Virginia.

The EPA estimates that between 9% and 34% of the drinking water sources in the United States may contain TCE. This estimate does not include private wells, which may also be contaminated especially if the wells are located near TCE disposal/contamination sites where leaching may occur. Reported levels in water are typically between 10 and 100 parts per billion (ppb).

Trichloroethylene (TCE) is an organic solvent that appears as a colorless liquid with a sweet odor and burning taste. TCE is not a proven carcinogen, however once TCE is introduced to the body, it is distributed and accumulates in adipose tissue. TCE exits the body unchanged in exhaled air and to a lesser degree in feces, sweat and saliva and may be rapidly metabolized in the liver. The symptoms of exposure to TCE are central nervous system problems that may include headache, drowsiness, hyperhydrosis and tachycardia, in more severe cases, a coma may result. Psychomotor impairment was noticed after inhalation exposure to 5,400 mg/m3 (1,000 ppm) for 2 hours in work place conditions. TCE vapors can cause eye irritation. High oral doses, 200 mL to 300 mL, can be toxic to the liver and kidneys. The lethal dose for an adult is generally 7,000 mg/kg body weight.

The EPA has set an enforceable standard for TCE called a Maximum Contaminant Level (MCL) of 5 ppb for TCE in drinking water. Since TCE is one of the most frequently reported groundwater contaminants, there is a need to find innovative ways of removing this solvent from the water supply.

### BRIEF SUMMARY OF THE INVENTION

The present invention provides a method for decontaminating water by chemically destroying organic contaminants through a series of oxidation and reductive dechlorination reactions. Contaminated water, i.e. water containing organic compounds, is treated by adding solid phase zerovalent iron and persulfate to the contaminated water, activating persulfate, and oxidizing and reducing said organic contaminants.

In certain embodiments, the organic contaminant is trichloroethylene, 1,1 dichloroethylene, 1,2 cis-dichloroethylene, 1,2 trans-dichloroethylene, or vinyl chloride. Other organic contaminants that can be destroyed by the method of the invention include, but are not limited to, 2,4,5-trichlorophenoxy acetic acid, pentachlorophenol, benzene, toluene, nitrobenzene, 2,4,6-trinitrotoluene, polycyclic aromatic hydrocarbons, carbon tetrachloride, chloroform, tetrachloroethylene (PCE), 2,3,7,8-tetrachlorodibenzo-p-dioxin (TCDD) and methyl tert-butyl ether (MTBE).

In certain embodiments, the method of the invention is effective for treating water at pH between about 2 and about 8. In preferred embodiments, the pH is about 2 or the pH is about 7.

In certain embodiments, the molar ratio of persulfate:zero valent iron:trichloroethylene is between about 5:1:1 and about 50:1:1. In some embodiments, the decontaminating reactions are effective as quickly as about 5 minutes and about 60 minutes. In cases where high concentrations of contaminating organic compounds are present, the water can be treated for longer periods of time, for example about 24 hours or for more than 24 hours.

### BRIEF DESCRIPTION OF THE DRAWINGS

FIG. 1 is a flow diagram depicting TCE degradation pathways;

FIG. 2 is a schematic diagram of the head space procedure;

FIG. 3 is a schematic diagram of the Micro-Liquid-Liquid-Extraction (MLLE) procedure;

FIG. 4 is a bar graph showing the comparison of ferrous iron activated persulfate oxidation/reduction and ZVI activated persulfate oxidation;

FIG. 5 is a bar graph showing the effects of pH on ZVI activated persulfate oxidation/reduction of TCE;

FIG. 6 is a bar graph showing the effects of persulfate dose on ZVI activated persulfate oxidation/reduction of TCE;

FIG. 7 is a graph showing the degradation of TCE by ZVI activated persulfate oxidation/reduction over 60 minutes; and

FIG. 8 is a graph showing the degradation of TCE by ZVI activated persulfate oxidation/reduction over 20 minutes.

### DETAILED DESCRIPTION OF THE INVENTION

The molecular formula for TCE is C₂HCl₃ and its chemical structure is illustrated in Formula 1. TCE has several trade names including but not limited to, Chlorylea, TRI-Plus M, Triad, Vitran, Perm-A-Chlor and Dow-Tri.

When TCE is in a soil medium, it will either evaporate or leach into ground water. Similarly, when TCE is introduced to surface water, it quickly evaporates, and therefore does not pose a major health hazard to aquatic life. In the gas phase, TCE is stable in air, but unstable in light or moisture. The behavior of TCE in water is based on the chemical makeup of the solution. For example, TCE is incompatible with strong caustics or alkalis; however it is chemically active with metals such as barium, lithium, titanium and beryllium. The general properties of TCE are included as Table 1.

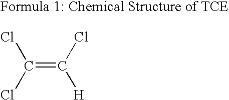

TABLE 1
Chemical Properties of TCE

| | |
|---|---|
| Density, g/mL | 1.46 |
| Solubility, mg/L @ 20° C. | 1000 |
| Henry's Law Constant, atm-m³/mol @ 20° C. | 0.00892 |
| Molecular Weight, g | 131.4 |
| Boiling Point | 86.7° C. |
| Melting Point | −73° C. |
| Vapor Pressure @ 0° C., mmHg | 19.9 |
| Vapor Pressure @ 20° C., mmHg | 57.8 |
| Log Octanol-Water Partition Coefficient | 2.42 |

Since pure TCE has a density greater than pure water, when TCE is present in the pure phase, it migrates down through water due to gravitational force and forms a pool of dense nonaqueous phase liquid (DNAPL). TCE can further contaminate an aquifer by spreading via dissolution, advection and dispersion.

Transformation and degradation processes of TCE in the environment are limited. TCE is conducive to aerobic and anaerobic biodegradation in soil at a slow rate, with a half-life estimated at six months to one year. TCE does not absorb ultraviolet light at wavelengths less than 290 nanometers; therefore it will not directly photolyze in the atmosphere or in water.

### Current Treatment Methods

Current water treatment plant operations such as coagulation, sedimentation, precipitation, softening, filtration and chlorination are ineffective at reducing the concentration of TCE to meet MCL standards set by the EPA. Air stripping is an effective method in removing TCE from water. Air stripping involves using a constant stream of air for TCE to transfer into. However, large volumes of air are needed for the transfer, and this process simply shifts the contaminant to the air, which still maintains an environmental hazard.

In another treatment method, granular activated carbon (GAC) is used to adsorb TCE. However there are limitations with the sorbent media since a sorbent has a specific capacity for a specific contaminant. With fixed bed adsorbents, when the sorption limit is reached the contaminant can breakthrough. Once a breakthrough has happened, the GAC media needs to be regenerated or replaced. At a concentration of 1 ppm TCE at a neutral pH and 20° C., the capacity of TCE on GAC is approximately 28 mg/g. In addition, other organic compounds can adsorb to GAC, thus lowering the efficiency of TCE adsorption.

The combination of air stripping and carbon adsorption is another mode of removing TCE from water. The first step would be to use air stripping to reduce concentrations of TCE to higher than the MCL. Then the water will be then sent through GAC as a second treatment step.

Biological processes of bacteria are also used to degrade TCE to CO₂, water and chloride ions. Anaerobic and aerobic degradation have been shown to work in laboratory experiments with the use of readily oxidizable substrates and nutrients. Certain bacteria species need a primary metabolite for the bacteria to produce the necessary enzymes to consume TCE. In laboratory experiments, microorganisms that oxidize methane have been shown to use co-metabolic oxidation to degrade TCE. Intermediate by products, such as dichloroethylene and vinyl chloride, have been seen in many experiments.

Another treatment for degrading organic contaminants is advanced oxidation, which involves the generation of hydroxyl free radicals (OH). Hydroxyl radicals react with dissolved constituents through a series of complex reactions until the constituents are completely mineralized. Hydroxyl radicals once generated, can attack organic molecules by radical addition, hydrogen abstraction, electron transfer and radical combination.

Chemicals that react quickly with hydroxyl radical are limited by the rate of diffusion of hydroxyl radical in water, which is approximately 10¹⁰ M⁻¹ s⁻¹, rather than the rate at which it attacks the chemical. Rate constants of 10⁹ M⁻¹ s⁻¹ are considered high enough to be effective for chemical oxidation treatments, while rate constants of 10⁸M⁻¹ S⁻¹ are considered too low to be effective. TCE reacts effectively with hydroxyl radicals with a second-order rate constant of 4.0×10⁹ M⁻¹ s⁻¹. Most of the aromatic compounds shown in Table 2 react effectively with hydroxyl radicals.

TABLE 2
Second-Order Rate Constants for the Reactivity of
Common Contaminants with Hydroxyl Radical

| Compound | k_{OH} · (M⁻¹ s⁻¹) |
|---|---|
| 2,4,5-Trichlorophenoxy acetic acid | 4.0 × 10⁹ |
| Pentachlorophenol | 4.0 × 10⁹ |
| Benzene | 7.8 × 10⁹ |
| Toluene | 3.0 × 10⁹ |
| Nitrobenzene | 2.9 × 10⁹ |
| 2,4,6-Trinitrotoluene | 4.3 × 10⁸ |
| Polycyclic aromatic hydrocarbons | 1.0 × 10¹⁰ |
| Carbon tetrachloride | <2 × 10⁶ |
| Chloroform | ≈5 × 10⁶ |
| Tetrachloroethylene (PCE) | 2.8 × 10⁹ |
| Trichloroethylene (TCE) | 4.0 × 10⁹ |
| 2,3,7,8-Tetrachlorodibenzo-p-dioxin | 4.0 × 10⁹ |
| (TCDD) | |
| Methyl tert-butyl ether (MTBE) | (3.9 ± 0.73) × 10⁹ |

Under optimal conditions for the degradation of TCE via advanced oxidation, the complete mineralization of TCE to chloride ions and CO₂ can occur. Typical oxidants used for advanced oxidation of TCE include potassium permanganate, hydrogen peroxide (Fenton's reagent), and ozone. Previous research has shown that Fenton's reagent is capable of oxidizing several chlorinated solvents in aqueous solutions including TCE and tetrachloroethylene (PCE) in soil slurries or soil columns.

Studies conducted on the effectiveness of Fenton's reagent for treating chlorinated organics, the reaction of hydroxyl radicals with organic material to completion produces water, carbon dioxide and salts. Studies have shown that during classical Fenton's oxidation of TCE, 78% of the initial TCE is degraded and 2.5 moles of H₂O₂ are consumed per mole of TCE. Approximately 1.9 moles of chloride are released per mole of TCE, showing that not all of the chlorine is displaced from the TCE. It has also been shown that Fenton's reagent was able to degrade aqueous phase TCE by 90 to 100% at a pH of 3. The experiments were also conducted in a sandy soil column and showed that Fenton's reagent with iron addition was able to oxidize TCE in the presence of soil.

Although previous research shows the effectiveness of Fentons Reagent in destroying contaminants such as TCE, there are shortcomings to Fenton's oxidation such as scavenging. Scavenging is when the hydroxyl radicals react with a non-target species such as nitrate and sulfate, which are typically found in groundwater. In addition, recent research has shown that Fenton's has a smaller lifetime in water than an oxidant such as persulfate. For example, the oxidation power of persulfate can sustain over a relatively long period of time (e.g., weeks). In contrast, iron-catalyzed hydrogen peroxide reactions rapidly (e.g., minutes to hours) deplete hydrogen oxide, and produce oxygen gas, and the resulting rapid increase in gas pressure in the subsurface has reportedly caused explosions and surface property damages. Therefore, the slow but steady oxidation power is a critical advantage for persulfate as an oxidant.

### Persulfate Oxidation

Sodium persulfate (Na₂S₂O₈) is a recent addition to the list of possible oxidants for TCE oxidation. Persulfate salts dissociate in water to form the persulfate anion (S₂O₈²⁻). The persulfate anion is a strong oxidant (E^{o}=2.01 V), but is kinetically slow in reacting with many organics. When the persulfate anion is chemically or thermally activated, it produces the sulfate free radical (SO₄⁻), which is a stronger oxidant than the persulfate anion (E^{o}=2.6 V). Once SO₄⁻ is formed it can destroy oxidizable agents including organic solvents such as TCE.

It was previously shown that thermally activated persulfate is able to degrade many frequently detected VOCs in contaminated soil and groundwater, with the rate of degradation increasing with higher temperature and oxidant concentration. Previously, thermally activated persulfate oxidation of TCE and 1,1,1-trichloroethane (TCA) in aqueous systems and soil slurries were compared at a temperature range from 40 to 99 degrees Celsius. Results showed little or no TCE/TCA degradation at a temperature of 20C, and increasing degrees of degradation at 40, 50 and 60 C. The TCE/TCA was mostly destroyed within 6 hours.

When SO₄⁻ is present in solution, radical interconversion reactions can occur, which will produce the hydroxyl radical (OH⁻) with an oxidation potential of 2.7 V. The interconversion reactions are described by the following equations:

All pHs: SO₄⁻+H₂O→SO₂⁴⁻+OH⁻+H⁺ (1)

Alkaline pH: SO₄⁻+OH⁻→SO₂⁴⁻+OH⁻ (2)

The rate constants for Eqs. (1) and (2) are of the orders of k4[H2O]<2·10⁻³ s⁻¹ and (6.5±1.0)·10⁷ M⁻¹ s⁻¹, respectively. Depending on the pH conditions of the contaminated water, both SO₄⁻ and OH⁻ are possibly responsible for the destruction of TCE. There are three ways in which the SO₄⁻ and OH⁻ react with organic compounds: hydrogen abstraction, hydrogen addition, and electron transfer. Sulfate radicals exhibit a higher standard reduction potential than hydroxyl radicals at neutral pH, but both radicals exhibit analogous reduction potentials under acidic conditions. Sulfate radicals usually participate in electron transfer, while hydroxyl radicals participate in hydrogen abstraction or addition reactions. The sulfate free radical predominates in acidic to neutral conditions, while the hydroxyl radical predominates in basic conditions.

### Persulfate Oxidation Activated by Ferrous Ion

The persulfate anion can be decomposed to form sulfate free radicals in the presence of transition metal activators, such as ferrous iron, at a temperature of 20 degrees Celsius. The stoichiometric relationship between, persulfate and ferrous ion is described in equations (3), (4) and (5). In addition to ferrous ion, ions of silver, copper, manganese, cereium and cobalt have also been studied.

2Fe²⁺+S₂O₈²⁻→Fe³⁺+2SO₄²⁻ (3)

Fe⁺²+S₂O₈→Fe⁺³+SO₄⁻+SO₄⁻² (4)

SO₄⁻+Fe⁺²→Fe⁺³+SO₄⁻² (5)

Based on the stoichiometry of equation (3), the reaction requires a Fe⁺²+S₂O₈²⁻ molar ratio of 2. The rate-determining step is the reaction between one S₂O₈²⁻ and one Fe⁺² to form SO₄⁻ as shown in equation (4), which then rapidly reacts with a second Fe⁺² as shown in equation (5). When the reactions have gone to completion, no sulfate free radical is available for further destruction of target organic contaminants. If the concentration of Fe⁺² were increased, the reactions in equations (4) and (5) would happen faster and end up in the reaction shown in equation (3). The conversion of Fe⁺² to Fe⁺³ results in the production of SO₄⁻, which destroys the target organic contaminant. One limitation to the use of ferrous iron as an activator of persulfate is that the fast reaction between SO4⁻ and excess Fe⁺² results in the destruction of SO4⁻ resulting in a lowering of the degradation efficiency of the target organic contaminant. This occurs because the TCE and excess ferrous ion are competing for the SO4⁻. To optimize this reaction, the reaction shown in Eq. (5) must be controlled by slowly providing small quantities of Fe⁺² activator which prevents the fast conversion of Fe⁺² to Fe⁺³ by the SO4⁻. Previous experiments using Fe⁺² as an activator under various molar ratios of S₂O₈²⁻/Fe⁺²/TCE in an aqueous system showed that partial TCE degradation occurred almost instantaneously and then the reaction stalled. It was found that by adding the Fe⁺² in small increments, the degradation efficiency was enhanced. An observation of oxidation-reduction potential (ORP) variations revealed that the addition of sodium thiosulfate to the ferrous ion activated persulfate system could significantly decrease the strong oxidizing conditions. Adding doses of thiosulfate after the reaction stalls converts Fe⁺³ to Fe⁺², which then activates the persulfate improves the destruction of the TCE. This reaction was found to happen rather quickly in water, but was slower in a soil medium.

In other previous research the ability of various chelating agents to hold Fe⁺² in soil slurries were compared. The chelating agents tested included: ethylenediamintetraacetic acid (EDTA), sodium triphosphate (STPP), citric acid and 1-hydroxyethane-1,1-diphosphonic acid (HEDPA). It was found that citric acid is the most effective chelating agent. Citric acid is a natural multidentate organic complexing agent that is environmentally friendly, and readily biodegradable, and has the ability to extract toxic metals from contaminated soils and sediments. TCE degradation of approximately 34%, 73% and 41% were observed in aqueous systems when EDTA-Fe⁺², STPP-Fe⁺² and HEDPA-Fe⁺² were used respectively. Degradation rates were lower in soil slurries with the same chelating agents and molar ratio, at 33%, 67% and 54% respectively. For the same conditions using citric acid as the chelating agent TCE degradation was approximately 90% in aqueous systems and approximately 80% in soil slurries. Almost 100% destruction of the TCE was found after 1 hr in aqueous and soil systems for a 24 hour period. Thus, the use of chelated ferrous ion is far superior to the use of unchelated ferrous ion as an activator.

### Zero Valent Iron

Previously, in the photo-assisted degradation of organophosphorous pesticides, Fe⁰ and Fe²⁺ were compared as catalysts in a UV/H₂O₂ system. Pesticide removal rates between 90 and 99 percent were observed after 240 minutes when 1 g of Fe⁰ or 50 um of Fe²⁺ was added to a UV/H₂O₂ system. Fe⁺³/H₂O₂ is the predominant reaction for the oxidation of organophosphorous pesticides. When only Fe²⁺ is present it is oxidized to Fe⁺³ by H₂O₂, and when Fe⁰ is present, it oxidizes to Fe²⁺ and then Fe⁺³ by dissolved oxygen, thereby resulting in the Fe⁺³/H₂O₂ reaction being dominant.

It has been shown that acid-washing of a metallic iron sample enhances the efficiency of TCE degradation by ZVI. The acid washing changes the formation of the oxides on the surface of the ZVI. When ferrous iron was added simultaneously with the TCE to water, the TCE degradation was reduced as the ferrous iron concentration was increased. This occurred because of the formation of passive precipitates of ferrous hydroxide that coated on the acid washed ZVI and prevented electron transfer from occurring. In samples where the ZVI was not acid washed, the electron transfer could take place despite the formation of the passive precipitates.

A study of the effectiveness of ZVI for reducing DNAPL TCE as opposed to TCE dissolved in water showed that ZVI could be used to destroy DNAPL TCE if the ZVI could be directly injected into the DNPL zone. The kinetic experiments showed that it took approximately 19.4 days for 5,880 mg/L of TCE to reduce to 1,000 mg/L which is the solubility of TCE in water.

ZVI activated persulfate oxidation of TCE using ozone saturated water in a soil slurry was effective in destroying TCE when the persulfate/TCE molar ratio was 10/1. Complete (100%) TCE destruction took place when the ZVI powder was added to the slurry test. All results showed that ZVI worked much better than ferrous iron in terms of TCE degradation efficiency.

### TCE Daughter Products

The potential intermediate daughter products of TCE reduction are dichloroethylenes (DCE) and vinyl chloride (VC). The dichloroethylenes are: cis-1,2-DCE (cis-DCE), trans-1,2-DCE (trans-DCE), and 1,1-DCE. DCE isomers are formed when the TCE is dechlorinated and are typically removed from water by volatilization. In air, cis-DCE and trans-DCE can react with hydroxyl radicals (photochemically produced) with a half life of 8 days and 3.6 days respectively. Cis-DCE is the most commonly found DCE isomer and accounts for 95 percent of the DCE in reduction reactions. Trans-DCE has the same chemical formula and molecular weight as cis-DCE, however it has a different physical makeup, as shown in Formulas 2-3. 1-1 DCE has the same chemical formula and molecular weight as cis-DCE and trans-DCE, however 1,1-DCE has a different orientation, as shown in Formulas 2-4. EPA has set the MCL's for cis and trans DCE at 0.07 mg/L and 0.1 mg/L, respectively.

Vinyl chloride is another daughter product of TCE reduction and forms when the DCE isomers are dechlorinated. VC has the molecular formula C₂H₃Cl and the structure shown by Formula 5. VC is a known human carcinogen and the US EPA set a drinking water maximum contaminant level of 2 μg/L for VC. The World Health Organization guideline is 0.5 μg/L for drinking water. Vinyl chloride is actually considered to be more harmful than the parent compound itself, TCE. The vinyl chloride is typically further dechlorinated to form ethene, which is the final end product of TCE reduction.

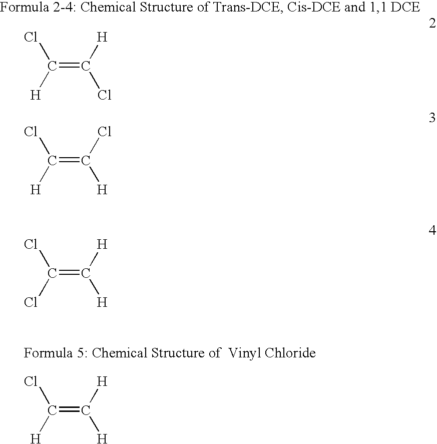

### TCE Degradation Pathways

In the current invention, TCE is being destroyed by two mechanisms, oxidation and reduction. The zero valent iron loses two electrons to provide ferrous iron. When ferrous iron activates persulfate, it produces the sulfate free radical, which is a powerful oxidant, the reaction is as described by equations (3)-(5). The general equation to describe the complete mineralization of TCE through persulfate oxidation is shown by equation (6). When TCE is oxidized by the sulfate free radical, the final end products of oxidation are carbon dioxide and chloride ions. The oxidant used in the methods of the invention is the sulfate free radical, which is the predominant radical species at a neutral pH. At basic pH values (8 or higher), the hydroxyl radical predominates the oxidation reaction.

TCE+SO₄⁻→CO₂+Cl⁻ (6)

The data presented herein in support of the methods of the invention show that the TCE is not only being oxidized but also reduced through reductive dechlorination. As TCE undergoes reductive dechlorination, it degrades into the daughter products mentioned above: DCE isomers, vinyl chloride and ethene. The data showed the presence of daughter products, specifically Cis 1,2 DCE and VC, which validated that some reduction was also occurring. The capability of ZVI as a reductant has been shown to be able to reduce TCE through dechlorination. However, the time in which the reaction takes place is on the magnitude of months. The reduction reaction taking place in the methods of the invention is very rapid and therefore the reductant is attributed to the persulfate rather than the ZVI. The general equation to describe the reduction of TCE to ethene is included as equations (7), (8) and (9).

TCE+Reductant→Cis1,2DCE (7)

Cis1,2DCE+Reductant→VC (8)

VC+Reductant→Ethene (9)

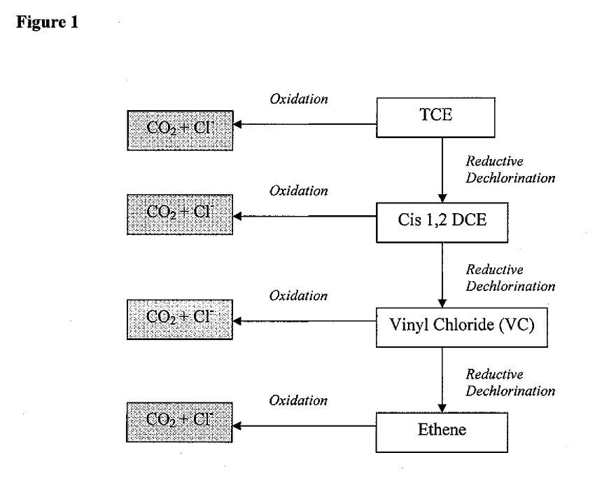

A portion of the DCE isomers and VC can be directly oxidized to carbon dioxide and chloride ions, while the rest is reduced further. The ethene can not be further reduced, but can be oxidized to carbon dioxide and chloride ions. FIG. 1 summarizes the degradation pathways of the TCE described herein, illustrating the simultaneous oxidation and reduction reactions that are destroying the TCE.

The current invention is directed to methods for the destruction of TCE. ZVI can be substituted for Fe²⁺ in an advanced oxidation by providing ferrous iron (by dissolution), thereby activating the persulfate. Therefore, ZVI activated persulfate oxidation is an effective tool for the destruction of TCE in contaminated waters.

### EXAMPLES

### Example 1

### Materials and Methods

All glassware was washed with Alconox detergent. The glassware was rinsed four times in tap water and once in E-pure water. Stock solutions were kept in a 4° C. refrigerator until use. The following chemicals were all A.C.S grade from Fisher Scientific. The TCE was an assay of 99.9%, and the sodium persulfate (Na₂S₂O₈) was an assay of 98.0%. The ZVI used was carbonyl iron micro powder supplied from ISP technologies. The water was from an RO pure ST reverse osmosis system, followed by an E-pure system supplied by Barnnstead/Thermolyne (Dubuque, Iowa). The cis-dichloroethylene (DCE) (5,000 μg/mL), trans-dichloroethylene (DCE) (5,000 μg/mL), 1,1-DCE (1,000 μg/mL) and Vinyl Chloride (VC) (100 μg/mL) standards, all diluted in methanol, were from Ultra Scientific (N. Kingstown, R.I.).

The gas chromatograph (GC) used was an Agilent 6890 Series GC with an Agilent 7683 Series Injector auto-sampler, and supplied with Hewlett Packard ChemStation software. Ultra high purity nitrogen gas from ABCO welding supplies (Waterford, Conn.) was used as the carrier gas. The injector was equipped with a 10 μL syringe. The sample was injected into a split-less inlet with an initial temperature of 50° C. and pressure of 8.06 psi. A 250 degree ECD detector was used. The column was a Restek Rtx-5SILMS with a nominal length of 30.0 m, nominal diameter of 320 μm and a nominal film thickness of 0.5 μm. The column was housed in the oven with an initial temperature of 28° C. After 7 minutes the temperature in the oven raised 10° C./minute until a temperature of 200° C. was reached. The output from the ECD detector is translated by the software into a peak area using the following constraints: initial slope sensitivity of 120, initial peak width of 0.8, and initial area and height rejects of 0.5. The sampling depth was set to 12 mm and the injection volume was 1 μL.

The retention times for TCE, cis-DCE, trans-DCE, 1,1-DCE and VC were found by running a known standard of each compound separately through the GC. The retention times are summarized in Table 3. Standard curves were created for each of the five chemicals. Testing was conducted on a triplicate of the lowest concentration and a triplicate of a sample blank to determine the method detection limit for each of the five chemicals. The presence of one or more of the by-products in each sample indicated that reduction was occurring.

TABLE 3
Retention Times

| Contaminant | Retention Time |
|---|---|
| TCE | 6.9 minutes |
| 1,1 Dichloroethylene | 2.7 minutes |
| 1,2 Cis-Dichloroethylene | 4.1 minutes |
| 1,2 Trans-Dichloroethylene | 3.2 minutes |
| Vinyl Chloride | 2.2 minutes |

### Preparation of Stock Solutions

Stock solutions of TCE and persulfate were pre-mixed to meet the various required molar ratios for experiments. TCE stock solutions were prepared in 250 mL brown glass bottles. First, the bottles were filled with E-pure water, and then the appropriate amount of TCE was pipetted directly into the 250 mL bottle from a jar of pure TCE. The stock solution was immediately capped, and foil wrapped before being placed on a stir plate. The solution was allowed to mix overnight in the dark at room temperature to ensure complete dissolution of TCE. All TCE stock solutions were prepared at a TCE concentration of 750 mg/L.

Persulfate stock solutions were prepared specific to the molar ratio required for the experiments. Persulfate stock solutions were also prepared in 250 mL brown glass bottles. First the bottles were filled with E-pure water and then the appropriate quantity of persulfate powder was measured and directly funneled into the stock solution. The amount of persulfate added was determined by the necessary persulfate/TCE molar ratio desired as well as the volume of the stock solution vessel. The bottle was then capped and placed on a stir plate for approximately 5 hours or until all the persulfate was dissolved in the water.

### Advanced Oxidation of TCE

The reaction vessels used in the experiments were 40 mL soda lime amber glass vials. Each 40 mL vial was filled up with the appropriate amount of water, persulfate, ZVI and TCE to make up the desired molar ratio of the sample. First, the Epure water was added, followed by the appropriate amount of sodium persulfate which was pipetted in the 40 mL vial directly from a pre prepared stock solution. Next, the appropriate amount of ZVI powder was measured on a digital mass balance and then added to the vials. The pH was then adjusted as necessary using 10 percent sulfuric acid or sodium hydroxide to a pH of 2, 3, 4, 5, 6, 7, 8, 9 and 10, each within ±0.1 pH units. The pH was measured with an Orion model 420A pH meter equipped with an Orion pH probe. The meter was calibrated each day with buffer solutions of pH 4.00, pH 7.00 and pH 10.00 (Fisher Scientific, Fair Lawn, N.J.). After the pH adjustment, the TCE was pipetted into the 40 mL vial directly from a prepared stock solution. The sample volume was also 40 mL so that there was no headspace in the vials. The vials were capped with Teflon lined screw caps immediately upon the addition of the TCE to minimize the loss due to volatilization. The 40 mL vials were then foil wrapped to prevent UV degradation and placed securely on an orbit shaker at 100 rpm and allowed to react for approximately 24 hours. After the 24 hour time period, the 40 mL vials were centrifuged for 10 minutes at 1000 rpm on an Eppendorf Centrifuge 5804. The vials were centrifuged due to the tiny ZVI particles which could clog the GC syringe. Following the centrifuging of the vials, the head space or micro liquid liquid extraction techniques were used to analyze the samples.

### Headspace Technique

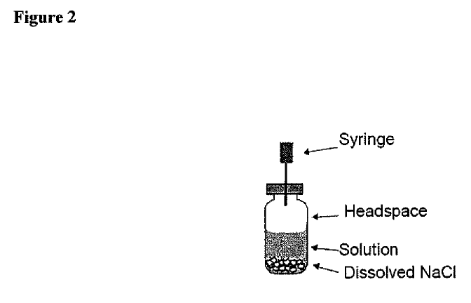

For this sampling method, 440 mg of sodium chloride was added to the sample vial in order to help volatilize compounds in solution. Then 1 ml of sample was added to the vial, and the remaining area is the headspace. After tightly capping the vial it was hand agitated for one minute and then placed on the shaker table allowing time for volatilization of the chemicals from the liquid. Then the vials were put on the auto sampler for GC analysis. The sample taken by the GC was taken from the headspace as seen in FIG. 2.

### Micro-Liquid-Liquid Extraction

Liquid Liquid extraction (LLE) was used to partition analytes between two immiscible liquids. Micro Liquid Liquid Extraction (MLLE) was performed with the auto sampler on the GC. Hexane was the solvent for extraction. 0.5 mL of solvent was added to 1 mL of sample in the standard 2 mL GC vials. The vial was then put on a vortex shaker and the two layers were allowed to separate followed by GC analysis.

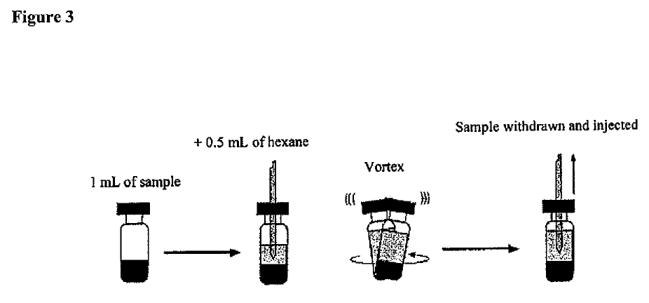

For each sample analyzed, 0.5 mL of hexane was added to 1 mL of oxidized TCE sample. The vials were tightly capped and then allowed to mix on a vortex shaker for approximately 15 minutes. Once mixed, they were allowed to separate for approximately 30 minutes. The vials were then analyzed on the GC with a 10 μL syringe at an injection depth of 12 mm and injection volume of 1 μL. The injection depth was determined by observation, which witnessed the syringe drawing liquid and not headspace. A schematic of the MLLE procedure is shown in FIG. 3.

### Example 2

### ZVI and Ozone Activated Persulfate Oxidation of TCE

Zero valent iron (ZVI) activated persulfate oxidation of TCE using 13.33 ml of ozone saturated water was most effective in destroying TCE when the persulfate/TCE molar ratio was 10/1. Complete (100%) TCE destruction took place when 0.50 gm of the ZVI powder was added to the slurry. Thus, ZVI was a much more efficient catalyst than ferrous iron for the persulfate degradation of TCE.

### Example 3

### ZVI Activated Persulfate Oxidation of TCE

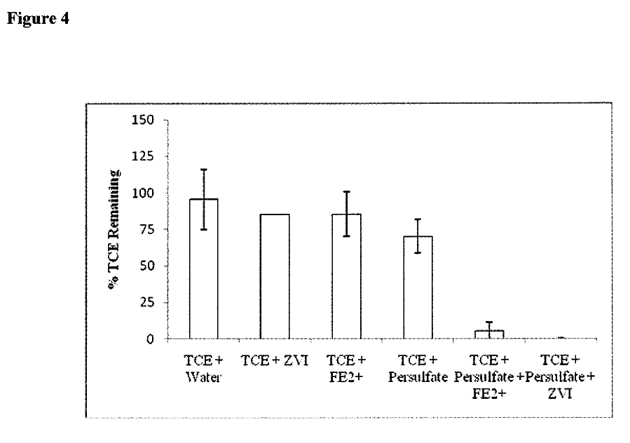

A set of control experiments designed to see the effectiveness of ZVI activated persulfate oxidation was performed. The experiment had four controls which were TCE and water, TCE and ZVI, TCE and ferrous iron, and TCE and persulfate. The other two samples were ZVI activated persulfate and ferrous iron activated persulfate. Six 40 mL reaction vessels were prepared by adding the necessary combinations of water, persulfate, ZVI or ferrous iron, and TCE, pH adjustment was done prior to adding the TCE and all samples were adjusted to a pH of 4. The molar ratio of persulfate/TCE/ZVI and persulfate/TCE/ferrous iron was kept consistent at 10/1/1. Upon addition of the TCE, the vials were tightly capped and foil wrapped then placed on an orbit shaker at 100 rpm for 24 hours. After 24 hours, the samples were analyzed using the headspace method. Each experiment was conducted in triplicate. The results are plotted in FIG. 4 showing the comparison of ferrous iron activated persulfate oxidation/reduction and ZVI activated persulfate oxidation. While both yield greater than 90% destruction of TCE, ZVI appears to have a higher destruction rate. All samples were at a pH of 4 and molar ration of 10/1/1 (Persulfate/ZVI or Fe²⁺/TCE). (Initial TCE=375 mg/L, error bars represent the 95% confidence interval, n=3 for all samples).

### Example 4

### Effect of pH

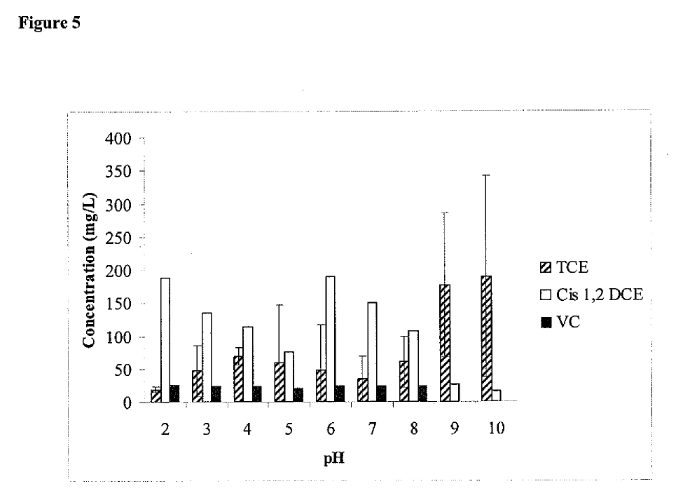

A set of experiments designed to investigate the effects of pH on TCE destruction was performed. A pH range from 2 to 10 was studied for full effect. Nine 40 mL vials were prepared with 375 mg/L TCE, with a persulfate/ZVI/TCE molar ratio of 10/1/1. Each reaction vial was then adjusted to a specified pH (2-10). All vials were allowed to react on the orbit shaker for 24 hours. After 24 hours, each vial was centrifuged for 10 minutes and then samples were extracted using the MLLE procedure and analyzed on the GC. Each experiment was run in triplicate, and averaged. The results graphed in FIG. 5 show the effects of pH on ZVI activated persulfate oxidation/reduction of TCE. Experiments were conducted in triplicate at a molar ratio of 10/1/1 (persulfate/ZVI/TCE). (Initial TCE concentration=375 mg/L, error bars represent 95% confidence intervals, n=3 for all pH values).

The results show that TCE destruction was seen for all samples after 24 hours. Greater than 80% destruction of TCE was seen at a pH range of 2 to 8. The greatest destruction of TCE occurred at a pH of 2 and 7, with 95 and 91% TCE being destroyed respectively. The presence of Cis 1,2 DCE and VC in the samples after 24 hours confirms that the decrease in TCE concentration is partially due to reduction reactions and not experimental error. The least amount of TCE destruction was seen at a pH of 9 and 10, which also coincided with the least amount of Cis 1,2 DCE and VC concentrations.

The results show that this reaction can occur over a wide range of pH values with one of the optimal pH values of about 2, which is extremely acidic. In contrast, maximum TCE degradation occurs at a pH of 7 using thermally activated persulfate oxidation. The optimal pH values for the methods of the invention using ZVI activated persulfate are about 2 and about 7.

For reductive dechlorination of TCE with ZVI optimal is a pH of 4.9. In the dechlorination of DNAPL TCE by ZVI, the TCE was successfully reduced at a pH range of 6.5 to 7.8. In the methods described herein, the reaction was optimized at pH values of about 2 and about 7. It is theorized that the reason for this dual pH optima is that simultaneous oxidation and reduction reactions are taking place by this method. However since greater than 80 percent TCE destruction was seen at a pH range from 2-8, this method has the flexibility to be applied in a variety of pH conditions.

### Example 3

### Effect of Persulfate Dose

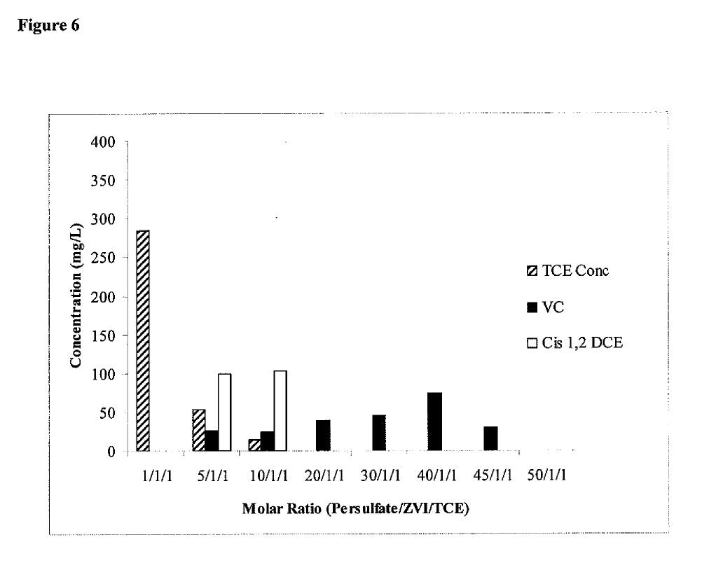

Varying molar ratios of persulfate/ZVI/TCE were tested at a constant pH, by altering the persulfate dose. Initially, six different reaction vessels were prepared with the following molar ratios of persulfate/ZVI/TCE: 1/1/1, 5/1/1. 10/1/1, 20/1/1/, 30/1/1, and 40/1/1, with the persulfate dose increasing every time. First the vessels were filled with Epure water, then the appropriate amount of persulfate was pippeted into the reaction vessels directly from different pre-prepared stock solutions. Each stock solution was prepared so that the amount of persulfate would satisfy the necessary molar ratios in the vials. Then the appropriate amount of ZVI powder was measured on a mass balance and added to the stock solution. Then the pH was adjusted to 7 for all samples using NaOH and/or HCL as needed. Finally, the TCE was added to the vials with an initial concentration of 375 mg/L. Once the TCE was added, the vials were capped, foil wrapped and placed on the orbit shaker for 24 hours. After 24 hours, all the vials were centrifuged for 10 minutes at 1000 rpm and then analyzed using the MLLE technique. The effects of persulfate dose on ZVI activated persulfate oxidation/reduction of TCE are shown in FIG. 6. All experiments were conducted at a pH of 7 and an initial TCE concentration of 375 mg/L. Increasing persulfate doses result in the formation and degradation of daughter products Cis 1,2 DCE and VC.

The results show that there was some TCE destruction with all the persulfate doses after 24 hours. The lowest molar ratio of 1/1/1 only yielded a TCE destruction of 24 percent and no associated daughter products. When the persulfate dose was increased to 5/1/1, the TCE concentration was reduced by 86 percent with a resulting Cis 1,2 DCE and VC concentration of 100 mg/L and 26 mg/L respectively. At a persulfate/ZVI/TCE molar ratio of 10/1/1, the TCE concentration as reduced by 96 percent, with no significant change in daughter product concentrations from a molar ratio of 5/1/1. Finally, when the molar ratio was increased to 20/1/1 and higher, the TCE destruction was greater than 97 percent and below the method detection limit of the TCE which was 10 mg/L. Cis 1,2 DCE also disappeared at persulfate doses of 20/1/1 and higher, but VC concentrations were steadily increasing, with a maximum concentration of 75 mg/L at a molar ratio of 40/1/1.

Up to the molar ratio of 40/1/1, an increase in persulfate yielded a decrease in TCE and an increase in Cis 1,2 DCE and VC. Once the persulfate dosage was increased enough, the Cis 1,2 DCE disappeared as well. However, the VC concentrations were continually increasing. Ultimately, the complete reduction of TCE including the reduction of VC was attained with an increased persulfate dosage. The molar ratio of persulfate/ZVI/TCE was increased to 45/1/1 and 50/1/1. The results are also plotted on FIG. 6. At a molar ratio of 45/1/1, the TCE is still destroyed by greater than 97 percent and the VC concentration was approximately 30 mg/L, which is 60 percent less VC than a persulfate dose of 40/1/1. At a molar ratio of 50/1/1, the VC concentration was below the method detection limit of 10 mg/L. This is a significant reduction in VC concentration from the previous persulfate doses of 40/1/1 and 45/1/1. This demonstrates that the reductant responsible for degrading the TCE and daughter products is persulfate related, as increasing the dose of persulfate results in higher TCE reduction as well the eventual reduction in daughter products as well.

When determining the amount of persulfate to use, one important factor to consider is cost. It is important to pick the dose that provides sufficient TCE degradation with the least amount of persulfate possible. As can be seen in FIG. 6, at molar ratios of 1/1/1 and 5/1/1, TCE degradation was below 90 percent, which indicates that the degradation was halted due to lack of sufficient persulfate. As persulfate concentration increased, so did the destruction of TCE. At a molar ratio of 10/1/1, the TCE destruction is at 96 percent, with relatively low daughter product concentrations. At molar ratios of 20/1/1 and higher, the TCE concentration is below the method detection limit. Therefore with an initial TCE concentration of 375 mg/L, a minimal persulfate dose of 10/1/1 or higher is required. Since a molar ratio of 10/1/1 is able to yield 96 percent TCE destruction, this would be the optimal dose as it utilizes the least amount of persulfate, which is considered more economical. In sites with TCE contamination, the concentration of TCE is typically much less than 20 mg/L. In the methods described herein, the initial concentration was 375 mg/L, and even with such a large concentration, a molar ratio of 5/1/1 was able to yield 86% TCE destruction. Thus, a considerably lower persulfate dose than 10/1/1 can achieve destruction, if the initial TCE concentration is less than 20 mg/L.

### Example 4

### Reaction Kinetics

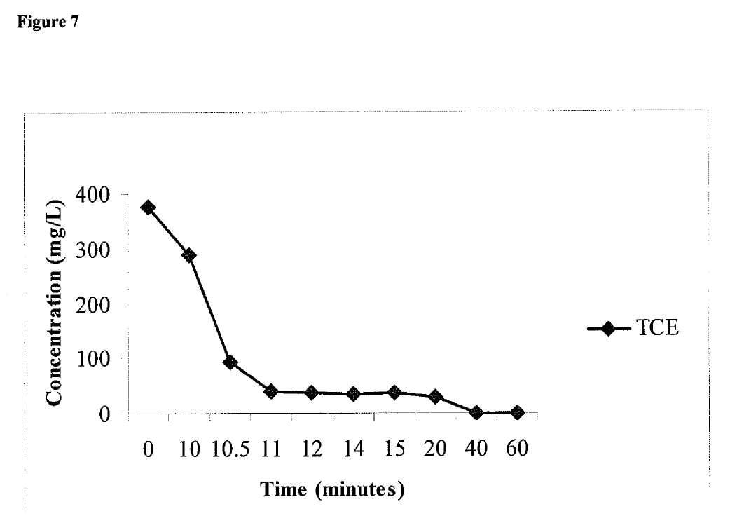

To determine the rate of TCE destruction 13.3 mL of water was added to a 40 mL vial. Then, persulfate was pipetted directly from a pre-prepared stock solution at a dose of 10/1/1 (persulfate/ZVI/TCE). Next the ZVI powder was measured and added to the 40 mL vial. The pH was then adjusted to 7, using NaOH or HCl as appropriate. Next, the TCE was added directly from the preprepared stock solution. Then the vials were capped, foiled and placed on the orbit shaker. Once the appropriate amount of time had passed for the reaction to take place, the sample was taken off the orbit shaker and the reaction was quenched by the addition of methanol. The amount of methanol added was five times the concentration of TCE. The reaction was allowed to proceed for 5, 10, 15, 20, 40 and 60 minutes. At a time of 60 minutes, the TCE was below the method detection limit. Because of the rapid loss of TCE between 10 minutes and 15 minutes, additional reaction times of 10.5, 11, 12, 13, and 14 minutes were examined. FIG. 7 shows the degradation of TCE by ZVI activated persulfate oxidation/reduction over 60 minutes. All experiments were conducted at a molar ratio of 10/1/1 (persulfate/ZVI/TCE), a pH of 7 and an initial TCE concentration of 375 mg/L.

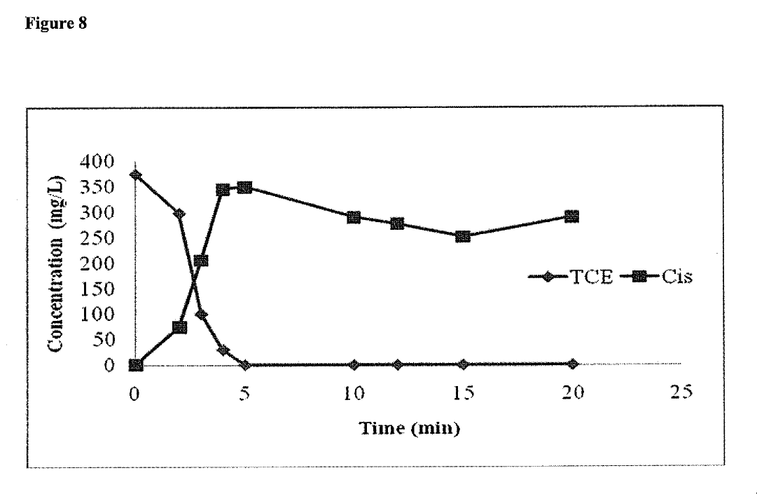

In an additional experiment the molar ratio of persulfate/ZVI/TCE was increased to 50/1/1 (five times the previous molar ratio), and the pH was adjusted to 2 instead of 7, since our pH experiments showed a maximum TCE destruction at a pH of about 2. The reaction times for the samples were 0, 5, 10, 12, 15 and 20 minutes. Since the destruction seemed to be taking place between, 0 and 5 minutes, additional samples were run at 2, 3 and 4 minutes. The results are plotted in FIG. 8.

The results in FIG. 7 show that the TCE is 90 percent destroyed in 11 minutes, which is a very fast reaction. The reaction is very rapid between 0 and 10.5 minutes, with the majority of the TCE degradation taking place in that time frame. Once the TCE reached the 90 percent destruction point, at 11 minutes, the reaction became very slow. Between the time interval of 11 and 40 minutes, there was no change in TCE concentration. At a reaction time of 40 minutes, the TCE was below the method detection limit.

FIG. 8 shows the degradation of TCE by ZVI activated persulfate oxidation/reduction over 20 minutes. All experiments were conducted at a molar ratio of 50/1/1 (persulfate/ZVI/TCE), a pH of 2 and an initial TCE concentration of 375 mg/L. The results in FIG. 8 show that the TCE is approximately 90 percent destroyed in 4 minutes. This reaction time is 7 minutes faster than that of the data shown in FIG. 7. This can be attributed to the fact that the persulfate dose in FIG. 8 is five times greater than the persulfate dose in FIG. 7. These results also show that the reaction happened very fast between 0 and 4 minutes, and then the reaction slowed down with the TCE concentration being below the method detection limit at 5 minutes. The presence of the byproduct cis 1,2 DCE was also detected. The concentration of the cis DCE appeared as the TCE destruction increased. The maximum cis DCE concentrations appeared at the 4 to 5 minute time interval, when the TCE was 90 percent or greater destroyed. Within a 24 hour reaction time, the cis completely disappears, as none was detected in the results shown in FIG. 6 for the same molar ratio.

What is claimed is:

1. A method of decontaminating water containing water contaminating organic compounds comprising contacting the water with zerovalent iron and persulfate.

2. The method of claim 1, wherein the persulfate is activated and the organic compounds are destroyed by oxidation and reduction.

3. The method of claim 1, wherein said organic contaminant is selected from the group consisting of: trichloroethylene, 1,1 dichloroethylene, 1,2 cis-dichloroethylene, 1,2 trans-dichloroethylene, and vinyl chloride.

4. The method of claim 1, wherein the pH of the water is between about 2 and about 8.

5. The method of claim 4, wherein the pH is about 2.

6. The method of claim 4, wherein the pH is about 7.

7. The method of claim 3, wherein the molar ratio of persulfate:zero valent iron:trichloroethylene is between about 5:1:1 and about 50:1:1.

8. The method of claim 1, wherein the persulfate and zero valent iron remain in contact with the contaminated water for between about 5 minutes and about 60 minutes.

9. The method of claim 1, wherein the persulfate and zero valent iron remain in contact with the contaminated water for about 24 hours.

10. The method of claim 1, wherein the persulfate and zero valent iron remain in contact with the contaminated water for more than 24 hours.
